(19) United States
(12) Patent Application Publication
(10) Pub. No.: US 2026/0246911 A1
(43) Pub. Date: Aug. 20, 2026

(54) METHOD FOR CALIBRATION OF A REPLICATION BOUNDARY OF A VIRTUAL RETINAL DISPLAY BASED ON A BEAMLET REPLICATION, BEAMLET REPLICATION-BASED VIRTUAL RETINAL DISPLAY, AND SMART GLASSES

(71) Applicant: Robert Bosch GmbH, Stuttgart (DE)

(72) Inventors: Carsten Reichert, Gomaringen (DE); Christian Adam Grafenburg, Stuttgart (DE)

(21) Appl. No.: 19/160,706

(22) PCT Filed: Apr. 22, 2024
(86) PCT No.: PCT/EP2024/060940

§ 371 Date: Aug. 28, 2025

(30) Foreign Application Priority Data
May 8, 2023 (DE) 10 2023 204 220.7

(51) Int. Cl. H04N 13/327; H04N 13/383; H04N 13/398

(52) U.S. Cl. CPC H04N 13/327; H04N 13/383; H04N 13/398; H04N 2213/001; H04N 2213/008

(57) ABSTRACT

Calibration of a replication boundary of a virtual retinal display based on a beamlet replication with a pupil tracking device. A first pupil position of a user eye is determined. A beamlet of the virtual retinal display and a beamlet replica are repeatedly and alternately projected into a sub-area of an eyebox of the virtual retinal display corresponding to the first pupillary position of the user eye. An image content of the beamlet projected at a first time point in the sub-area of the eyebox and image content of the beamlet replica projected at the second time point into the sub-area of the eyebox are shifted relative to one another by changing a setting of the virtual retinal display and/or smart glasses, and/or a distortion and/or optical distortion is adjusted by changing a setting of the virtual retinal display and/or smart glasses.

### BACKGROUND

Augmented reality (AR) glasses, which present both the real environment and virtually displayed image content simultaneously, are conventional. Depending on the technology, different combiners are used, which transmit light from the environment to the eye and superimpose on it the light of artificially-generated image content. In accordance with the free-space combiner principle of action, in AR glasses the lens (or an additional offset or integrated optical element) overlays the artificial image content with the environment by acting as a reflective or diffracting surface for the artificial image content. The superimposition may result from the reflection on a refractive index transition or on diffractive structures (e.g., holograms). A holographic-optical element (HOE) located in the lens may be employed as a free-space combiner. Furthermore, in the related art, laser light is used for the projection of the artificial image content. The beam generated by the laser is configured to have a small diameter at the location of an entry pupil of an eye of the AR glasses user. This small circle of confusion in the pupil plane is also called “beamlet”. Thus, a beamlet is a small area, preferably in the pupil of the user eye, through which the single beams of all pixels pass. The entire image information of the image content is present in a beamlet. If the pupil of the user eye moves due to the user's eye movement, the user only sees a non-vignetted artificial image content for as long as the beamlet is still within an eyebox of the AR glasses-user system.

Furthermore, it is understood that a hologram may contain several different diffractive combiner functions such that within a hologram layer several beamlets, instead of one beamlet, may be produced simultaneously, which are then spatially separate copies of one another (beamlet replicas). In this case, both beamlets are active simultaneously and move synchronously.

Calibration of AR glasses according to the explained free-space combiner principle of action is usually very complex, especially since, for example, for each pattern built it is necessary to accurately measure and calibrate which mirror positions of a MEMS mirror system projecting the artificial image content correlate with pixels in the displayed artificial image content. This calibration effort is multiplied by the need to do so for all laser colors of a laser projection system of the AR glasses, e.g., for red, green, and blue, as well as for all outputted beamlets and beamlet replicas from the AR glasses. In particular, calibration at a boundary of a beamlet replication area requires a transfer between the beamlets to be achieved ideally without changing the image content between beamlet and beamlet replica. The tolerance for this is usually only around 0.2 px and is thus only achieved with great effort. In addition, due to the circumstances discussed, very accurate alignment of the AR glasses to the user's eye distance is required in the conventional systems, which can usually only be done by a trained professional.

### SUMMARY

According to an example embodiment of the present invention, a method for calibration is provided, in particular at least for a field calibration, of a replication boundary of a beamlet replication-based virtual retinal display (retinal scan display) with a pupil tracking device, wherein, in at least one method step, at least one first pupillary position of a user eye of a user of the virtual retinal display, in particular, a sub-area of an eyebox of a system of virtual retinal display and user is determined, wherein, in at least one further method step at least one beamlet of the virtual retinal display and at least one beamlet replica of the beamlet are repeatedly and alternatingly projected into a sub-area of the eyebox of the virtual retinal display corresponding to first pupil position of the user eye, wherein, in particular, the sub-area of the eyebox in the first pupil position overlaps at least with a part of the replication boundary to be calibrated of the virtual retinal display, and wherein, in at least one calibration step, an image content of the beamlet projected into the sub-area of the eyebox at a first time and an image content of the beamlet replica projected into the sub-area of the eyebox at a second time are shifted relative to each other by changing a setting of the virtual retinal display and/or smart glasses comprising the virtual retinal display, in particular, at least in an eyebox plane of the virtual retinal display, and/or wherein, in the calibration step, distortion and/or optical distortion of the image content of the beamlet projected at the first time into the sub-area of the eyebox and distortion and/or optical distortion of the image content of the beamlet replica projected at the second time into the sub-area of the eyebox will be adapted to each other by changing a setting of the virtual retinal display and/or smart glasses comprising the virtual retinal display.

In the method according to an example embodiment of the present invention, the high calibration requirements for calibration of the replication boundary can advantageously be met in a particularly simple manner. Advantageously, the user can perform this calibration himself. Advantageously, inexpensive calibration can be enabled. Advantageously, a high level of user satisfaction may be reached, in particular because the calibration is achievable by the user himself in an inexpensive and time-saving manner (no visit to a specialist is required). Advantageously, a user-specific “perfect” calibration can be enabled. In addition, a recalibration can advantageously be achieved, e. g., when passed on to another user or when the virtual retinal display is maladjusted, e.g., due to aging effects. Advantageously, an expensive exact “end-of-line” calibration can be omitted during manufacturing. Advantageously, a user-specific calibration can also be enabled, for example if the user uses a preferred laser color, its robustness and resolution can be optimized, or if the user requires only limited image content (often displays the same images), this image content can be particularly preferably optimized by the proposed calibration.

A “pair of smart glasses” is in particular to be understood as a wearable (head-mounted display), by means of which information can be added to the field of view of a user. Smart glasses preferably make augmented reality applications and/or mixed reality applications possible. In particular, a pair of smart glasses comprises a virtual retinal display (also known as a retinal scan display or light field display), in particular a generally conventional one from the related art. In particular, the virtual retinal display is configured to sequentially scan image content by deflecting at least one light beam, in particular a laser beam, from at least one time-modulated light source, such as one or more laser diodes of a laser projector, and to image it directly onto the retina of the user eye by means of optical elements. The image source is in particular designed as an electronic image source, for example as a graphics output, in particular an (integrated) graphics card, of a computer or processor, or the like. The image data are in particular formed as color image data, e.g., RGB image data. In particular, the image data may be designed as still or moving images, e.g., videos. In particular, the laser projector unit is provided to generate the image data and to output them via a visible (RGB) laser beam. In particular, the laser projector unit comprises RGB laser diodes, which generate the visible laser beam. In particular, the laser projector unit comprises an infrared laser diode, which generates the infrared laser beam. Preferably, the visible laser beams and the infrared laser beam are combined to form a common laser beam. The infrared laser diode can be integrated in a laser diode system comprising the RGB laser diodes, or the infrared laser beam can be coupled via optical elements into the visible laser beam generated by a separate laser diode system. The smart glasses may also comprise a pupil tracking device (eye tracking system). The pupil tracking device can be implemented in a conventional manner, e.g., via a camera observing the user eyes, via an analysis of a back reflection of an infrared laser signal, e.g., using the dark-pupil effect or the bright-pupil effect.

In particular, during the calibration of the replication boundary, the transfer of artificially generated image content generated by the virtual retinal display and output to the user between two beamlets, in particular between the beamlet and the beamlet replica, is optimized. In the transfer of the artificially generated image content calibrated by the method, an offset of the image content before and after the transfer is to be less than 0.5 pixels, preferably less than 0.3 pixels, and preferably less than 0.2 pixels. Preferably, the offset of the image content before and after transfer is intended to be small enough for the user to no longer see it or to see it only with concentrated observation. In particular, in the calibration of the replication boundary, the offset of the image content of the beamlets on both sides of the replication boundary is adapted to one another. It is possible that the replication boundary is a sharp line in space. In this case, there is no area in which, at least at different times, both beamlets to be calibrated to each another can be located. However, it is also alternatively possible that the replication boundary is not a sharp line, but rather an overlap region. In that case, the beamlets to be calibrated to each other may at least alternately (not simultaneously) occupy an identical location. Preferably, the replication boundary (horizontal or vertical) runs approximately in a mid-point of the eyebox and/or the sub-area of the eyebox. In particular, the replication boundary (horizontal or vertical) runs approximately in a mid-point of a pupil area determined by the pupil tracking device. Preferably, a “field calibration” should be understood as a calibration, which can be performed by the user himself, preferably without the need for complicated aids. Preferably, field calibration is feasible at many different locations, preferably at almost any location, for example at the user's home, office, in nature, the interior of a vehicle, etc.

In particular, the beamlet replication-based virtual retinal display comprises at least one diffractive optical element (DOE), preferably an HOE, which is configured to replicate a laser projection unit output of the virtual retinal display to form the beamlet replica. In particular, the first pupil position of the user eye corresponds to a particular direction of view, preferably predetermined by a calibration procedure, of the user wearing the virtual retinal display. Preferably, the user is advised not to move their eyes during calibration, in particular to keep them in the first pupil position. The beamlet is in particular a beam, which preferably comprises all artificially generated image content. The beamlet is designed in particular to enter the user eye and, preferably, to impinge on a retina of the user eye. In a repeated, alternating projection of two beamlets to a particular location, the two beamlets are preferably directed so as to return to the location immediately in succession. In particular, the sub-area of the eyebox corresponds to an area within the virtual retinal display in which the user eye, in particular a pupil of the user eye, must be located, so that at a first time the beamlet and at a second time the beamlet replica completely strikes the pupil of the user eye and thus enters the user eye/is perceptible by the user. In particular, the sub-area of the eyebox is determined by means of the pupil tracking device based on the first pupil position of the user eye. In particular, the sub-area of the eyebox is formed by an area in a pupillary plane of the virtual retinal display in which a beamlet can be currently located such that the image content output by the virtual retinal display can enter the user's eye in the respective pupil position without vignetting. In particular, the beamlet jumps out of the respective sub-area of the eyebox when the beamlet jumps into the same sub-area of the eyebox and vice versa.

In particular, the change in the setting of the virtual retinal display, which adjusts the displacement of the image content from the beamlets to one another and/or which adjusts the distortion and/or the visual distortion of the image content in the beamlets to one another, can be done automatically, in particular controlled via software, or manually, in particular mechanically and/or optically, e.g., via an adjustable optical system/lens and/or mirror system. When executing via a software, this may be performed internally in the smart glasses or externally, e.g., in a cloud or on a cell phone coupled to the smart glasses. For example, for calibration, in particular for displacement/adjustment, a transformation between a projection mirror position of a MEMS system of the virtual retinal display (“rasterizer image”) and a displayed video image could be adjusted. In particular, the method described is provided for an application in a virtual retinal display of smart glasses/AR glasses. Alternatively, the method described may also be provided for an application in binoculars, a telescope, a microscope, a periscope, other smart glasses, such as virtual reality glasses, cycling glasses, diving goggles, motorcycle helmet visors, safety goggles, etc., and/or ophthalmic examination devices respectively equipped with virtual retinal displays. The terms “provided” and/or “configured” are in particular understood to mean specifically programmed, designed, and/or equipped. An object being provided and/or configured for a particular function is in particular understood to mean that the object fulfills and/or performs this particular function in at least one application state and/or operating state.

It is further provided according to an example embodiment of the present invention that the virtual retinal display outputs at least one first calibration marker during the projection of the beamlet into the eyebox, and that the virtual retinal display, during the projection of the beamlet replica into the eyebox, outputs at least one second calibration marker, in particular one distinct from the first calibration marker, wherein in the calibration step, at least the two calibration markers are shifted relative to another by changing a setting of the virtual retinal display and/or the smart glasses, in particular by moving the image contents and/or adjusting the distortions and/or optical distortion of the image contents within the sub-area of the eyebox, the two calibration markers preferably being brought into a relative position corresponding to an optimal calibration, preferably into an at least partial overlap with one another. This can advantageously make simple and/or intuitive user calibration possible. Advantageously, a high accuracy of calibration can be achieved. Preferably, the distinct calibration markers have different geometric shapes. Preferably, the different geometric shapes of the calibration markers correspond to each other, so that advantageously an optimal relative position of the calibration markers to each other is intuitively detectable for the user. In particular, the virtual retinal display switches the output of the calibration marker synchronously with the alternating projection of the beamlet and beamlet replica into the sub-area of the eyebox. The relative position of the calibration markers corresponding to an optimal calibration may be an exact or partial overlap or may also be a different relation of the calibration markers to each other.

It is also provided according to an example embodiment of the present invention that in at least one further method step, at least the beamlet and at least the beamlet replica of the beamlet are projected in alternately repeated fashion into a further sub-area of the eyebox of the virtual retinal display, which corresponds to a second pupil position of the user eye distinct from the first pupil position, wherein, in particular, the further sub-area of the eyebox in the second pupil position overlaps at least with a further part of the replication boundary to be calibrated of the virtual retinal display. This can advantageously enable an especially precise calibration. Advantageously, a calibration valid for a variety of user viewing directions can be obtained as a result. Preferably, the method is repeated for additional further pupil positions at the replication boundary. For example, the method is repeated at at least four, preferably at least five, and preferably at least ten positions on the replication boundary. It is also possible that a virtual retinal display will generate more than one replication, thereby creating more than one replication boundary (e.g., one vertical and one horizontal for three beamlet replicas). In that case, the method may be repeated at a plurality of positions of each of the replication boundaries, respectively.

According to an example embodiment of the present invention, if in the process, in at least one further calibration step, in which the user eye is preferably in the second pupil position, at least the two calibration markers are shifted relative to one another by a further setting change of the virtual retinal display and/or the smart glasses, in particular by shifting the image contents and/or adjusting the distortions and/or the optical distortion of the image contents within the further sub-area of the eyebox, this may advantageously enable a particularly precise calibration that is valid in particular for a variety of user viewing directions. In particular, the further calibration step proceeds at least substantially identically to the calibration step, with the important difference that the user eye takes the second pupil position instead of the first pupil position. Comparable additional further calibration steps are preferably performed for all further pupil positions calibrated in the method.

According to an example embodiment of the present invention, it is also provided that the repeated alternating projection of the beamlet and the beamlet replica into the respective sub-area of the eyebox be generated by alternately shifting the respective beamlet in and out of the respective sub-area of the eyebox, in particular by means of a MEMS mirror system of a (laser) projector of the virtual retinal display. As a result, a simple and/or reliable calibration of the replication boundary may advantageously be achieved.

Furthermore, according to an example embodiment of the present invention, it is provided that, in the settings change of the virtual retinal display and/or the smart glasses made in the calibration step, at least one adjustment of a transformation is made between a projection mirror position of a MEMS mirror system of a laser projector unit of the virtual retinal display and a video image, output via the beamlets, of the virtual retinal display. As a result, a simple and/or reliable calibration of the replication boundary may advantageously be achieved.

According to an example embodiment of the present invention, it is further provided that, in at least one further calibration step, an image sharpness of the virtual retinal display is readjusted following the change in the settings of the virtual retinal display and/or the smart glasses. An optimal calibration can thus be advantageously achieved. Preferably, an image sharpness can thereby be calibrated additionally and/or also be kept high after a recalibration. For example, to adjust and/or calibrate the image sharpness of the artificially generated image content, a focal length of variable lenses of an optical imaging system of the virtual retinal display may be adjustable in particular manually by the user or automatically. For example, after a displacement or distortion/optical distortion of the calibration markers, a sub-area of a calibration marker, e.g., an edge of a calibration marker, can be manually or automatically sharpened, e.g., by adjusting the focal length of the variable lenses. Alternatively, at least one test image/pattern different from the calibration markers may also be displayed to the user, the sharpness impression of which being then used to calibrate the focal length of the variable lens.

In this context, according to an example embodiment of the present invention, it is additionally provided that in the further calibration step at least one of the calibration markers is used in addition to adjusting the image sharpness of the virtual retinal display, in particular by adjusting a focal length of a variable lens of the virtual retinal display such that a contrast and/or an edge area of at least the calibration marker is optimized. As a result, an optimal individual calibration of the virtual retinal display may advantageously be achieved.

In addition, according to an example embodiment of the present invention, it is provided that an image frequency of the alternating projection is selected such that the user may perceive the beamlet and the beamlet replica simultaneously. Advantageously, a particularly high level of user comfort may be achieved during the calibration. Advantageously, a smooth calibration display can be enabled, which in particular allows for particularly accurate, simple, and/or fast calibration. Preferably, the frame rate is at least 16 frames per second or more. The frame rate thus exceeds the speed resolution of the human eye and a smooth image impression is advantageously created. Alternatively, however, a frame frequency below 16 frames per second, e.g., of only one frame per second or of only two frames per second, is also possible.

Further, according to an example embodiment of the present invention, a beamlet replication-based virtual retinal display with a calibratable, in particular a field-calibratable, replication boundary is provided, with a pupil tracking device for determining a first pupil position of a pupil of a user eye of a user of the virtual retinal display, with at least an optical system comprising at least one laser projector unit with a MEMS mirror system at least for a repeatedly alternating projection of at least one beamlet and at least one beamlet replica in a sub-area of the eyebox corresponding to the first pupillary position of the user eye, wherein, in particular, the sub-area of the eyebox overlaps with at least a portion of the calibratable replication boundary of the virtual retinal display in the first pupil position, and having at least one setting unit, which at least a shift of an image content projected into the sub-area of the eyebox at a first time via the beamlet into the sub-area of the eyebox and an image content projected at a second time via the beamlet replica into the sub-area of the eyebox relative to each other by a mechanical and/or electronic adjustment operation of the virtual retinal display and/or smart glasses comprising the virtual retinal display, in particular, at least in an eyebox plane of the virtual retinal display, and/or which at least a distortion and/or an optical distortion of the image content projected into the sub-area of the eyebox at the first time via the beamlet and the image content projected into the sub-area of the eyebox at the second time via the beamlet replica by a mechanical and/or electronic adjustment operation of the virtual retinal display and/or smart glasses comprising the virtual retinal display. Advantageously, a particularly user-friendly virtual retinal display and/or smart glasses can thereby be provided. Advantageously, a simple, inexpensive, and/or time-saving calibratable virtual retinal display and/or smart glasses may be provided. Advantageously, a particularly high precision of the output of the virtual retinal display and/or the smart glasses, in particular via a particularly large eyebox, can be provided.

In addition, according to an example embodiment of the present invention, smart glasses, in particular AR (Augmented Reality) glasses, having the beamlet replication-based virtual retinal display, are provided, which provide the same advantages for smart glasses.

The method according to the present invention, the beamlet replication-based virtual retinal display according to the present invention, and the smart glasses according to the present invention are not to be limited to the application and embodiments described above. In particular, for fulfilling a functionality described herein, the method according to the present invention, the beamlet replication-based virtual retinal display according to the present invention, and the smart glasses according to the present invention can comprise a number of individual elements, components, units, and method steps that deviate from a number mentioned herein. In addition, for the value ranges specified in this disclosure, values within the mentioned limits are also to be considered disclosed and usable as desired.

### BRIEF DESCRIPTION OF THE DRAWINGS

Further advantages result from the following description of the figures. An exemplary embodiment of the present invention is illustrated in the figures. The figures and the description contain numerous features in combination. A person skilled in the art will expediently also consider the features individually and combine them to form meaningful further combinations.

FIG. 1 shows a schematic representation of a pair of smart glasses with a virtual retinal display, according to an example embodiment of the present invention.

FIG. 2 schematically shows a top view of an exemplary eyebox in an eyebox plane of the virtual retinal display with a beamlet and a beamlet replica, according to an example embodiment of the present invention.

FIG. 3 shows a further schematic top view of the exemplary eyebox with the beamlet and the beamlet replica during calibration of an eyebox replication boundary, according to an example embodiment of the present invention.

FIG. 4 shows a schematic flow diagram of a method for calibrating the virtual retinal display replication boundary, according to an example embodiment of the present invention.

FIG. 5 shows an exemplary image content of a calibration display of the virtual retinal display in an inadequately calibrated initial situation, according to the present invention.

FIG. 6 shows an exemplary image content of the calibration display of the virtual retinal display in a calibrated state, according to the present invention.

### DETAILED DESCRIPTION OF EXAMPLE EMBODIMENTS

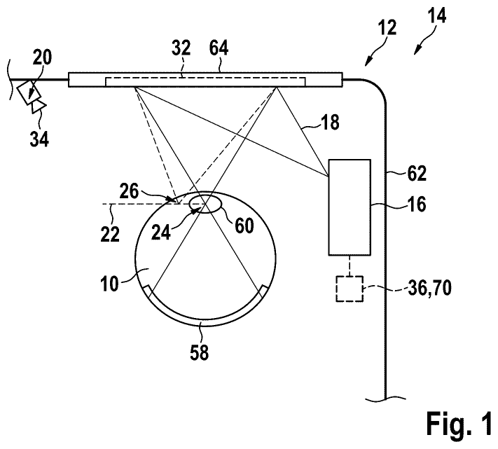

FIG. 1 is a schematic illustration of a pair of smart glasses 14. Alternatively, a different AR display device than smart glasses 14 would also be possible. The smart glasses 14 comprises a virtual retinal display (retinal scanning display) 12. The virtual retinal display 12 is configured as a beamlet replication-based virtual retinal display 12. The smart glasses 14 comprise a glasses frame 62. The smart glasses 14 comprise eyeglass lenses 64. A user eye 10 is illustrated in FIG. 1 by way of example. The user eye 10 has a pupil 60. The user eye 10 has a retina 58. The virtual retinal display 12 comprises a laser projector unit 16. The laser projector unit 16 comprises an optical system (not shown in detail) comprising a MEMS mirror system. The laser projector unit 16 is configured at least to generate scanned laser beams. The laser projector unit 16 outputs a scanned laser beam 18. The scanned laser beam 18 generates an image display/image content of the virtual retinal display 12. The laser projector unit 16 is at least partially integrated into the glasses frame 62. The eyeglass lens 64 forms part of the virtual retinal display 12 by comprising part of an optical system of the virtual retinal display 12, e.g., an integrated holographic-optical element (HOE) 32. The HOE 32 forms a deflection element, which is provided to redirect the laser beam 18 output by laser projector unit 16 to the user eye 10. The HOE 32 is configured to replicate the image display/image content output by the laser projector unit 16. Alternatively or additionally, a segment lens or other optical replication elements introduced into the optical path of the laser beam 18 could also be configured to replicate the image display/image content. The laser beam 18 is focused on the user eye 10 via the optical system of the virtual retinal display 12, in particular via the HOE 32. The laser beam 18 is focused through the optical system of the virtual retinal display 12, in particular through the HOE 32, into a pupil plane/eyebox plane 22 of the virtual retinal display 12. In the pupil plane/eyebox plane 22, the laser beam 18 has a smallest diameter. A circle of confusion of the focused laser beam 18 in the pupil plane/eyebox plane 22 forms a beamlet 24, 26. By replicating the image display/image content output by the laser projector unit 16 in the optical system of the virtual retinal display 12, a beamlet 24 and a beamlet replica 26 are formed in the pupil plane/eyebox plane 22. The beamlet 24 has a diameter smaller than a minimum diameter of the pupil 60 of the user eye 10. For a non-vignetting representation of the image display/image content, all of the individual rays of all pixels of the scanned laser beam 18 contained in the beamlet 24, 26 pass through the pupil 60 of the user eye 10 and are imaged on the retina 58 of the user eye 10. A movement of the user eye 10, e.g., when changing the viewing direction, may cause the beamlet 24 to slip outside of the pupil 60. In order to maintain the user's perception of the image display/image content, a further beamlet 26, e.g., the beamlet replica 26, must overlap with the pupil 60 in the new eye position of the user eye 10 after the eye movement. An area, within which the pupil 60 of the user eye 10 can move such that a full image display/image content remains visible, is referred to as eyebox 28.

The smart glasses 14/the virtual retinal display 12 comprises a pupil tracking device 20 for monitoring an eye position of the user eye 10/a pupil position of the pupil 60 of the user eye 10 in the virtual retinal display 12. The pupil tracking device 20 is configured to determine a first pupil position 40 of the pupil 60 of the user eye 10 of the user of the virtual retinal display 12. The pupil tracking device 20 is configured to determine further pupil positions 56 of the pupil 60 of the user eye 10 of the user of the virtual retinal display 12. By way of example, the pupil tracking device 20 comprises a sensor unit 34. The sensor unit 34 may be configured as a laser feedback interferometry (LFI) sensor. The sensor unit 34 may be configured as an eye-tracking camera. The sensor unit 34 may be configured to capture back reflections of an infrared laser beam (not shown) from the user eye 10. The virtual retinal display 12 comprises a computer unit 36. The computer unit 36 is configured at least to evaluate the detected back reflections from the user eye 10. The computer unit 36 is configured to track and/or monitor an eye position of the user eye 10 and/or a pupillary position of the pupil 60 from the detected back reflections from the user eye 10.

The smart glasses 14/the virtual retinal display 12 comprises a setting unit 70. The setting unit 70 is configured to shift an image content projected at a first time via the beamlet 24 in the sub-area 44 of eyebox 28 (cf. FIG. 3) and an image content projected at a second time via the beamlet replica 26 in the sub-area 44 of the eyebox 28 relative to each other in the eyebox plane 22 of the virtual retinal display 12 by a mechanical and/or electronic setting operation. The setting unit 70 is configured for adapting a distortion and/or optical distortion of the image content projected at the first time via the beamlet 24 in the sub-area 44 of the eyebox 28 and the image content projected at the second time via the beamlet replica 26 in the sub-area 44 of the eyebox 28 by a (further) mechanical and/or electronic setting operation.

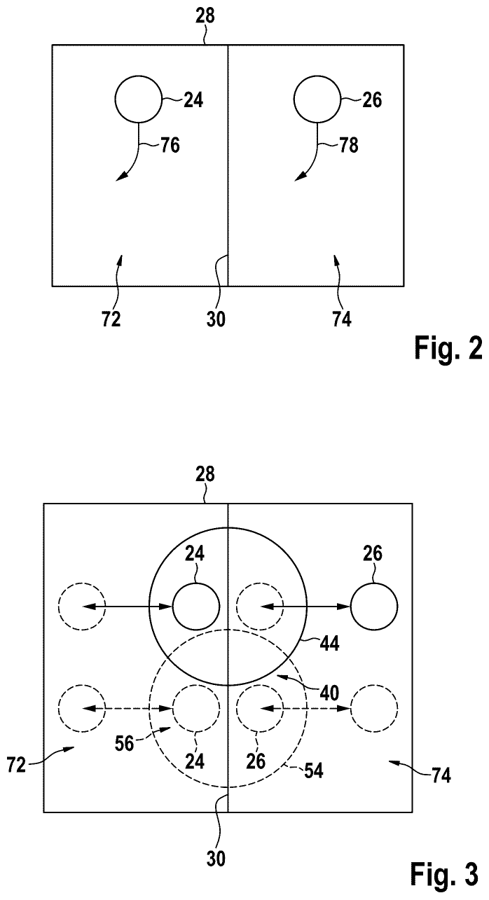

FIG. 2 schematically shows a top view of an exemplary eyebox 28 of the virtual retinal display 12. The eyebox 28 shown in FIG. 2 corresponds to the area in the eyebox plane 22 in which either the beamlet 24 or the beamlet replica 26 can enter the user eye 10 through the pupil 60 at different pupil positions 40, 56. The replication of the beamlet 24 doubled the overall size of the eyebox 28. A first half 72 of the eyebox 28 denotes the area of the eyebox 28 that may be reached by the beamlet 24. A second half 74 of the eyebox 28 denotes the area of the eyebox 28 that may be reached by the beamlet replica 26. The eyebox 28 has a replication boundary 30. The two halves 72, 74 are separated (spatially) from each other by the replication boundary 30. The replication boundary 30 is calibratable. The replication boundary 30 is field-calibratable. As the beamlet 24 shifts, the beamlet replica 26 moves analogously. Both beamlets 24, 26 are simultaneously active and move synchronously (see arrows 76, 78 of FIG. 2). If the pupil 60 now migrates from the first half 72 of the eyebox 28 across the replication boundary 30 into the second half 74 of the eyebox 28, a type of transfer of the image display/image contents takes place. In the example shown, the beamlet 24 must jump to the left edge of the first half 72 so that the beamlet replica 26 also jumps to the left edge of the second half 74, where the pupil 60 crossing the replication boundary 30 is located. The laser projector unit 16 is capable of generating this jump of the beamlets 24, 26 by means of the MEMS mirror system.

The laser projector unit 16 is also configured to repeatedly and alternately project the beamlet 24 and the beamlet replica 26 into the sub-area 44 of the eyebox 28 by means of the MEMS mirroring system. FIG. 3 shows this situation by way of example using the eyebox 28 and the beamlets 24, 26 moved therein. In FIG. 3, the sub-area 44 of the eyebox 28 is also shown in the exemplary first pupil position 40. To perform a calibration of the replication boundary 30, the sub-area 44 of the eyebox 28 overlaps with a part of the replication boundary 30 to be calibrated. To calibrate the replication boundary 30, the beamlet 24 and the beamlet replica 26 are displayed quasi simultaneously by performing a transfer of the above-described type on each frame of the virtual retinal display 12. In FIG. 3, this is exemplified for the first pupil position 40. In addition, FIG. 3 indicates a second pupil position 56, which corresponds to another direction of view of the user eye 10 which is to be calibrated. In the second pupil position 56, an analogous method with a “framewise” transfer is then performed following the first pupil position 40. This is repeated for a number of further pupil positions along the replication boundary 30, in particular until the entire replication boundary 30 of the eyebox 28 is covered by calibrations.

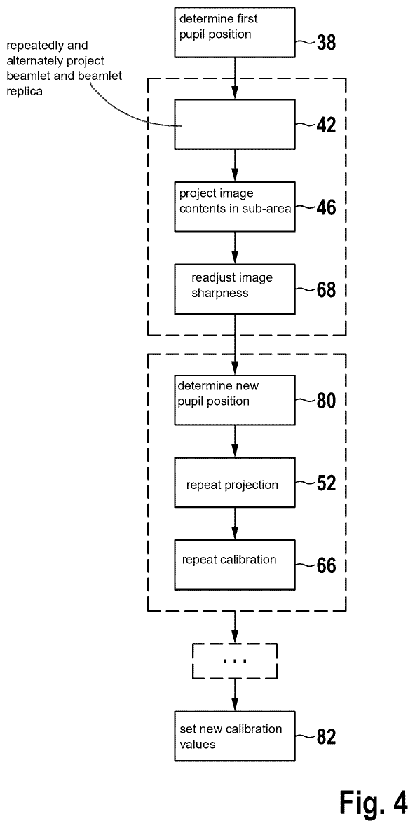

FIG. 4 shows a schematic flow diagram of a method for calibration, in particular a field calibration, of the replication boundary 30 of the beamlet replication-based virtual retinal display 12. In at least one method step 38, a first pupil position 40 of the user eye 10 is determined. In at least one further method step 42, the beamlet 24 and the beamlet replica 26 are repeatedly and alternately projected into the sub-area 44 of the eyebox 28 of the virtual retinal display 12 corresponding to the determined first pupil position 40 of the user eye 10. A frame rate of the alternating projection is selected such that the user may perceive the beamlet 24 and the beamlet replica 26 simultaneously. The repeatedly alternating projection of the beamlet 24 and the beamlet replica 26 into the sub-area 44 of the eyebox 28 is generated by sliding the respective beamlet 24, 26 in and out of the sub-area 44 of the eyebox 28 via the laser projector unit 16, in particular by means of the MEMS mirror system of the laser projector unit 16.

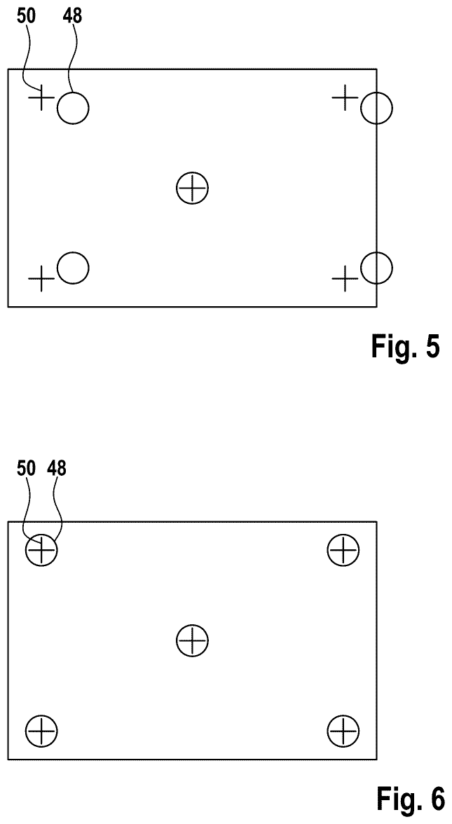

The virtual retinal display 12 comprises a light engine. The light engine may be part of the computer unit 36 or developed separately of the latter. The virtual retinal display 12, in particular by means of the light engine, provides at least a first calibration marker 48 during the projection of the beamlet 24 into the eyebox 28 (cf. FIGS. 5 and 6). The virtual retinal display 12 outputs at least a second calibration marker 50, in particular by means of the light engine, during the projection of the beamlet replica 26 into the eyebox 28 (cf. FIGS. 5 and 6). The second calibration marker 50 is configured differently from the first calibration marker 48. In the example shown in FIGS. 5 and 6, the first calibration marker 48 is configured as at least one circle. In the example shown in FIGS. 5 and 6, the second calibration marker 50 is formed as at least one cross.

FIG. 5 shows an exemplary initial situation of a calibration display of the method. Due to a relative calibration error and/or distortion error, calibration markers 48, 50 are not on top of one another. The task of the user of the virtual retinal display 12 when calibrating is, for example, to align the calibration markers 48, 50 with one another by controlling them via the computer unit 36 or via an external device, such as a smartphone or the like, e.g., by sliding them on top of one another until a situation as exemplified in FIG. 6 is achieved. Thus, the virtual retinal display 12/the smart glasses 14 receives a correction of its original (FIG. 4) calibration. This calibration is repeatable as many times as desired and for as many users as desired.

In a calibration step 46, an image content of the beamlet 24 projected at a first time in the sub-area 44 of the eyebox 28 (i.e., in the example depicted in FIGS. 5 and 6, the first calibration marker 48) and an image content of the beamlet replica 26 projected at a second time in the sub-area 44 of the eyebox 28 (i. e., in the example shown in FIGS. 5 and 6, the second calibration marker 50) are shifted relative to one another by means of a setting change of the virtual retinal display 12 and/or the smart glasses 14 in the eye box plane 22 of the virtual retinal display 12. Alternatively or additionally, in the calibration step 46, the two calibration markers 48, 50 could be shifted relative to one another and/or adjusted to one another by an alternative or additional setting change of the virtual retinal display 12 and/or the smart glasses 14, such as adjusting the distortions of the image contents and/or an optical distortion of the image contents within the sub-area 44 of the eyebox 28. The displacement and/or distortion occurs until calibration markers 48, 50 take on a relative position to one another corresponding to an optimal calibration. In the setting change of the virtual retinal display 12 and/or the smart glasses 14 made in the calibration step 46, an adjustment of a transformation is made between a projection mirror position of the MEMS mirror system of the laser projector unit 16 and a video image of the virtual retinal display 12 output via the beamlets 24, 26. In at least one further calibration step 68, an image sharpness of the virtual retinal display 12 is readjusted following the change in setting of the virtual retinal display 12 and/or the smart glasses 14. This may occur, for example, by adjusting a focal length of a variable lens of the optical system of the laser projector unit 16. For readjustment, for example, a structure of one or both calibration markers 48, 50 may be sharpened by changing the settings on the laser projector unit 16, e.g., via the computer unit 36. In this case, in the further calibration step 68 at least one of the calibration markers 48, 50 is used in addition to adjusting the image sharpness of the virtual retinal display 12.

This calibration method/scheme may be repeated in further method steps 52 and calibration steps 66, which in particular also have the above-described pattern, but are performed along the replication boundary 30 at the second and further pupil positions 56 of the user eye 10. Prior to each iteration, a new pupil position 56 of the user eye 10 is determined in at least one method step 80. In the end, if the user agrees with the calibration, the new calibration values are set in at least one further method step 82 in the virtual retinal display 12/in the smart glasses 14.

Each time, the light engine projects the beamlets 24, 26 into the respective sub-area 44, 54 of the eyebox 28 that overlaps with the replication boundary 30. The user eye 10 then perceives the calibration markers 48, 50. The user then controls the setting unit 70 (e.g., the computer unit 36, or a mobile device, such as a smartphone, connected to the smart glasses 14) such that the image content of the beamlets 24, 26 is changed. The light engine then projects slightly adjusted calibration markers 48, 50 according to the user input. This process continues until the user indicates that there is an optimal match between the calibration markers 48, 50, e.g., the marks + and O. Thereafter, the process begins again at a different pupil position 40, 56, and thus also other beamlet positions, until enough positions along the replication boundary 30 are gone through and the replication boundary 30 has been calibrated.

1-11. (canceled)

12. A method for at least one field calibration of a replication boundary of a beamlet replication-based virtual retinal display with a pupil tracking device, the method comprising:
determining at least a first pupil position of a user eye of a user of the virtual retinal display;
repeatedly and alternately projecting at least one beamlet of the virtual retinal display and at least one beamlet replica of the beamlet into a sub-area of an eyebox of the virtual retinal display corresponding to the first pupil position of the user eye, wherein the sub-area of the eyebox overlaps at least with a portion of the replication boundary to be calibrated of the virtual retinal display in the first pupil position;
in at least one calibration step: (i) shifting an image content of the beamlet projected at a first time in the sub-area of the eyebox and image content of the beamlet replica projected at a second time in the sub-area of the eyebox relative to one another by changing a setting of the virtual retinal display and/or smart glasses including the virtual retinal display, at least in an eyebox plane of the virtual retinal display, and/or (ii) adjusting a distortion and/or optical distortion of the image content of the beamlet projected at the first time in the sub-area of the eyebox and a distortion and/or an optical distortion of the image content of the beamlet replica projected at the second time in the sub-area of the eyebox relative to each other, by changing a setting of the virtual retinal display and/or the smart glasses including the virtual retinal display.

13. The method according to claim 12, wherein:
the virtual retinal display outputs at least one first calibration marker during projection of the beamlet into the eyebox;
the virtual retinal display outputs at least a second calibration marker, different from the first calibration marker, to the eyebox during the projection of the beamlet replica; and
in the at least one calibration step at least the first and the second calibration markers are shifted relative to one another by changing a setting of the virtual retinal display and/or the smart glasses, including by shifting the image content of the beamlet and the image content of the beamlet replica and/or by adjusting the distortions and/or optical distortion of the image content of the beamlet and the image content of the beamlet replica within the sub-area of the eyebox, into a relative position corresponding to an optimal calibration.

14. The method according to claim 12, wherein, in at least one further method step, at least the beamlet and at least the beamlet replica of the beamlet are projected in repeatedly alternating fashion into a further sub-area of the eyebox of the virtual retinal display, which corresponds to a second pupil position of the user eye different from the first pupil position, wherein the further sub-area of the eyebox in the second pupil position overlaps at least with a further part of the replication boundary to be calibrated of the virtual retinal display.

15. The method according to claim 13, wherein, in at least one further calibration step, at least the first and second calibration markers are shifted relative to one another by a further change in setting of the virtual retinal display and/or the smart glasses, by sliding the image content of the beamlet and the image content of the beamlet replica and/or adjusting the distortions and/or the optical distortion of the image content of the beamlet and the image content of the beamlet replica within the further sub-area of the eyebox.

16. The method according to claim 12, wherein the repeatedly alternating projection of the beamlet and the beamlet replica into the sub-area of the eyebox is generated by sliding the respective beamlets in and out of the sub-area using a MEMS mirror system of a laser projector unit of the virtual retinal display.

17. The method according to claim 12, wherein, in the setting change of the virtual retinal display and/or the smart glasses performed in the calibration step, at least one adjustment of a transformation is performed between a projection mirror position of a MEMS mirror system of a laser projector unit of the virtual retinal display and a video image of the virtual retinal display output via the beamlet and the beamlet replica.

18. The method according to claim 12, wherein, in at least one further calibration step, an image sharpness of the virtual retinal display is readjusted after the setting change of the virtual retinal display and/or the smart glasses.

19. The method according to claim 18, wherein, in the further calibration step, at least one of the first and second calibration markers is used for adjusting the image sharpness of the virtual retinal display by adjusting a focal length of a variable lens of the virtual retinal display such that a contrast and/or an edge area of the at least one of the first and second calibration markers is optimized.

20. The method according to claim 12, wherein a frame rate of the alternating projection is selected such that the user may perceive the beamlet and the beamlet replica simultaneously.

21. A beamlet replication-based virtual retinal display having a field-calibratable, replication boundary, comprising:
a pupil tracking device configured to determine a first pupil position of a pupil of a user eye of a user of the virtual retinal display;
at least one optical system including at least one laser projector unit with a MEMS mirror system configured to repeatedly alternating project at least one beamlet and at least one beamlet replica into a sub-area of an eyebox corresponding to the first pupil position of the user eye, wherein the sub-area of the eyebox in the first pupil position overlaps at least with a portion of the calibratable replication boundary of the virtual retinal display; and
at least one setting unit: configured to shift an image content projected at a first time via the beamlet into the sub-area of the eyebox and an image content projected at a second time via the beamlet replica into the sub-area of the eyebox relative to each other by a mechanical and/or electronic setting operation of the virtual retinal display and/or smart glasses including the virtual retinal display, a least in an eyebox plane of the virtual retinal display, and/or configured to distort and/or optically distort the image content projected at the first time via the beamlet into the sub-area of the eyebox and the image content projected at the second time via the beamlet replica into the sub-area of the eyebox by a mechanical and/or electronic adjustment operation of the virtual retinal display and/or the smart glasses including the virtual retinal display.

22. Smart glasses, comprising:
a beamlet replication-based virtual retinal display having a field-calibratable, replication boundary, including:
a pupil tracking device configured to determine a first pupil position of a pupil of a user eye of a user of the virtual retinal display;
at least one optical system including at least one laser projector unit with a MEMS mirror system configured to repeatedly alternating project at least one beamlet and at least one beamlet replica into a sub-area of an eyebox corresponding to the first pupil position of the user eye, wherein the sub-area of the eyebox in the first pupil position overlaps at least with a portion of the calibratable replication boundary of the virtual retinal display; and
at least one setting unit: configured to shift an image content projected at a first time via the beamlet into the sub-area of the eyebox and an image content projected at a second time via the beamlet replica into the sub-area of the eyebox relative to each other by a mechanical and/or electronic setting operation of the virtual retinal display and/or smart glasses including the virtual retinal display, a least in an eyebox plane of the virtual retinal display, and/or configured to distort and/or optically distort the image content projected at the first time via the beamlet into the sub-area of the eyebox and the image content projected at the second time via the beamlet replica into the sub-area of the eyebox by a mechanical and/or electronic adjustment operation of the virtual retinal display and/or the smart glasses including the virtual retinal display.
